(19) United States
(12) Patent Application Publication
(10) Pub. No.: US 2016/0249088 A1
(43) Pub. Date: Aug. 25, 2016

(54) SYSTEM AND METHOD FOR DELAYED DIGITAL VIDEO RECORDING

(71) Applicant: Layer3 TV, Inc., Denver, CO (US)

(72) Inventors: Jeffrey BINDER, Denver, CO (US); Lindsay GARDNER, Santa Monica, CA (US); Charles A HASEK, IV, Denver, CO (US)

(73) Assignee: Layer3 TV, Inc., Denver, CO (US)

(21) Appl. No.: 14/628,200

(22) Filed: Feb. 20, 2015

(51) Int. Cl. H04N 21/4147; H04N 21/239; H04N 21/6587; H04N 21/6543; H04N 21/458; H04N 21/262

(52) U.S. Cl. CPC H04N 21/4147; H04N 21/458; H04N 21/2625; H04N 21/6587; H04N 21/6543; H04N 21/239

(57) ABSTRACT

The present invention relates to a system and method for managing network delivery of media content to a client device and, more particularly, to processing a scheduler service request to determine to deliver to the user at least one asset by the digital video recorder (DVR), network DVR (nDVR) or network content storage systems utilizing one or more user characteristics so as to conserve bandwidth of the content delivery network. The system and method may use a device DVR, a network DVR, network content storage system or any combination of the previous, to delay the delivery and storage of content media to conserved bandwidth across the CDN network based on one or more user characteristics in response to a “pause” or “record” or other DVR function service request, A scheduler service is used in connection with a digital video recording system and method that can operate upon a “pause” of linear and/or a “record” nonlinear content to delay any caching and/or storing content media at a predetermined time to conserved bandwidth across the CDN network based on one or more user characteristics. The nDVR storage system and/or network content storage system may be utilized used for storage of the content where nothing is directly streamed to the user from the network. The DVR, content storage, scheduler service, and resource manager can quickly deliver the content to the user account on demand such as, for example, to the DVR in-home with policy restrictions, e.g. for playback only from the home DVR. The scheduler service and resource manager may be configured to recognize which content is watched after the original airing, whereby the media content data may then be delivered to the local in-home DVR at the time the program is typically watched by the user and/or subscriber.

### FIELD OF THE INVENTION

The present invention relates to a system and method for managing network delivery of media content to a client device and, more particularly, to processing a scheduler service request to determine to deliver to the user at least one asset by the digital video recorder (DVR) or network DVR (nDVR) utilizing one or more user characteristics so as to conserve bandwidth of the content delivery network.

### BACKGROUND OF THE INVENTION

In a content delivery network (CDN) when a user seeks to record digital media content (e.g. a linear broadcast event or a non-linear VOD title that has been ingested and metadata pushed into the system), distribution of the media content consists of on-demand or push-based mechanisms that move content from an origin server to the client servers closest to the user's device. Typically, a CDN is implemented as a combination of a server and communication infrastructure with resource management control for the routing and distribution of the digital media content. The media content delivery usually comprises a set of origin servers that push content to one or more tiers of cache servers located at strategic locations (e.g., Internet network access points, Internet Points of Presence, and the like) for delivering copies of the media content to requesting end users. The routing and delivery of media content is utilizes a resource manager and scheduler service to accept and respond to requests client servers in a way that, for media content delivery, minimizes a given client's response time and, for the ultimate streaming media delivery, provides for the highest quality viewing for the user.

While this CDN infrastructure is suitable for routing and delivery of media content to the user that is actually being watched, other user requests of the resource manager and scheduler service should not be prioritized for immediate delivery. For example, a user may choose at a particular moment in time to request from the scheduler service to record multiple assets of media content (e.g. all episodes of an entire season of the media content) by the digital video recorder (DVR) of the device or network DVR (nDVR) service. In conventional CDN infrastructures, the resource manager will start the delivery across the CDN infrastructure to the client server for storage on the user's device according the scheduler service (e.g. when the new program airs, or if a VOD asset as available) whereby such delivery utilizes the available bandwidth of the CDN. Conventional resource managers do not determine whether it can delay the delivery of content media to conserve bandwidth based on one or more user characteristics such as, for example, the particular user watches the program at the time airs, the user is merely time-shifting the recording for later viewing, the user has selected all episodes for later viewing (e.g. user will not be binge watching), and other user scheduler service inputs that may not be a request for immediate viewing.

It would be an improvement over conventional digital video recording systems to provide a system and method of device DVR and/or network DVR, or both, that can delay the delivery and storage of content media to conserved bandwidth across the CDN network based on one or more user characteristics.

### SUMMARY OF THE INVENTION

It is an object of the present invention to provide a system and method for digital video recording on a device DVR and/or a network DVR, or both, that can delay the delivery and storage of content media to conserved bandwidth across the CDN network based on one or more user characteristics.

It is an object the apparatus, system and method of the present invention to provide a scheduler service in connection with a digital video recording system and method that can operate upon a “pause” of linear and/or nonlinear content to delay any caching and/or storing content media at a predetermined time to conserved bandwidth across the CDN network based on one or more user characteristics.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Description of the Embodiments, which is to be read in association with the accompanying drawings, which are incorporated in and constitute a part of this specification, show certain aspects of the subject matter disclosed herein and, together with the description, help explain some of the principles associated with the disclosed implementations, wherein:

FIG. 1 is a schematic diagram illustrating system and method of content delivery and recording of linear and non-linear media content in accordance with an embodiment of the present invention;

FIG. 2 is a schematic diagram illustrating the digital video recording system and method of recording linear and non-linear media content in accordance with an embodiment of the present invention; and

FIG. 3 is a flowchart illustrating the method of recording linear and non-linear media content in accordance with an embodiment of the present invention.

### DESCRIPTION OF THE EMBODIMENTS

Non-limiting embodiments of the present invention will be described below with reference to the accompanying drawings, wherein like reference numerals represent like elements throughout. While the invention has been described in detail with respect to the preferred embodiments thereof, it will be appreciated that upon reading and understanding of the foregoing, certain variations to the preferred embodiments will become apparent, which variations are nonetheless within the spirit and scope of the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “some embodiments”, “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are provided for the purposes of illustrating some embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “DVR” refers to a device or application software that digitally compressing analog and/or video feeds and storing these feeds in memory (i.e. that records video in a digital format to a hard-drive, system memory, a disk drive, USB flash drive, SD memory card, SSD or other local or networked mass storage device, etc.). The term includes set-top boxes (STB) with direct to disk recording facility, portable media players (PMP) with recording, recorders (PMR) as camcorders that record onto Secure Digital memory cards and software for personal computers which enables video capture and playback to and from a hard disk drive. The term “digital” referring to the compression and storage technology, not the transmitted video images.

As used herein the term “network digital video recording” or “nDVR” refers to a device or application software that stores digital images or video on the network “in the cloud” (e.g. directly from the IP-network into a networked mass storage device). As used herein the term “Quality of Services” or “QoS” refers to a device or application software device is one that is capable, in order to comply with bandwidth limitations of a network, of limiting the transmission rate it uses for transmission or reception over the network. A QoS device may be capable of negotiating with a system resource manager for varying amounts of bandwidth.

As used herein the term “application programming interface” or “API” refers to a software component in terms of its operations, inputs, outputs, and underlying types is a set of routines, protocols, and tools for building software applications.

The invention is a delayed DVR system and method for recording digital content to ensure quality of the user experience is generally designated as numeral 100. According to an embodiment, the delayed DVR system and method 100 may be formed and implemented using a digital video recorder (DVR) integrated a devices (e.g. a set-top box) and/or on a network digital video recorder (nDVR). The delayed DVR system and method 100 provides a user the ability to backing up and playing recorded program material linear and non-linear content media (e.g. TV broadcast programs, VOD, and digital video). The system and method 100 may be implemented in a content delivery network (CDN) system using computers to distribute copies of data placed at various nodes of a network by subscription to the device of a user. According to one embodiment, the content media may be, for example, linear broadcasting and non-linear or VOD content media (audio and podcast hosting, video delivery, live streaming, flash streaming), downloadable objects (media files, software, documents), live streaming and database queries. Numerous devices are available for a user to play the content media such as TV, HD-monitors, mobile devices

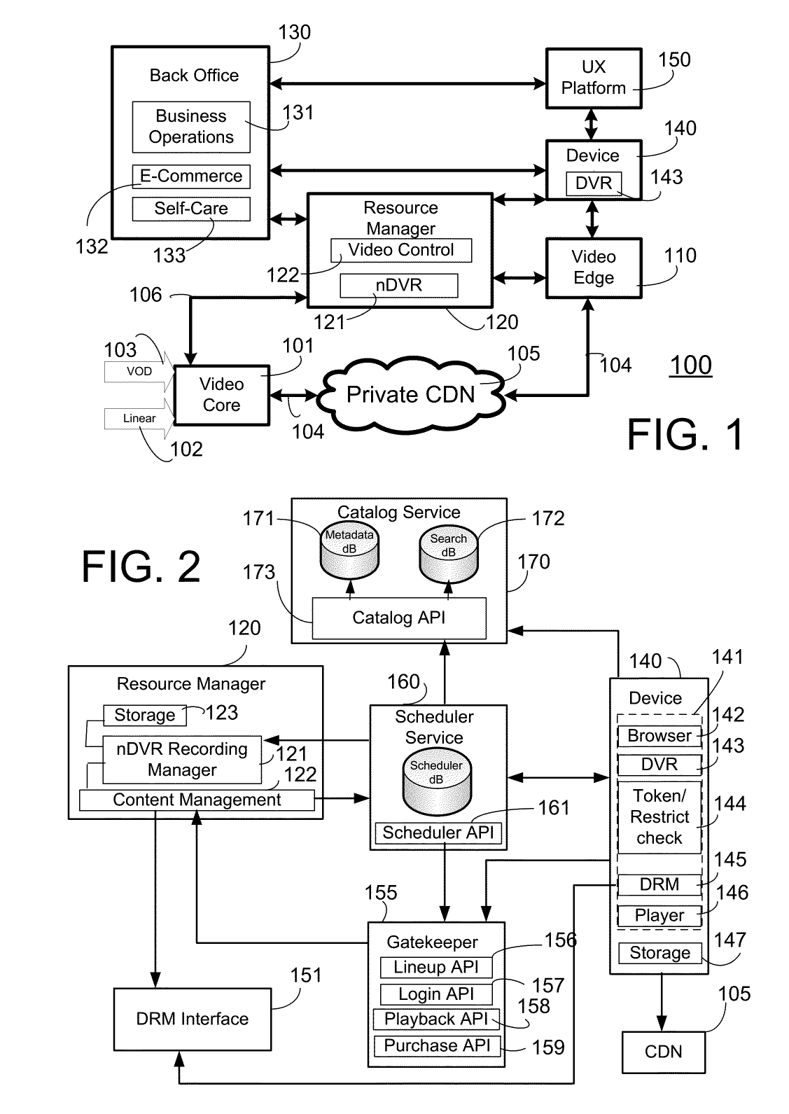

Referring to FIGS. 1 through 3, a delayed digital video recorder (DVR) system and method 100 is adapted for content processing and communication generally comprises a video core 101 for ingesting and packaging linear 102 (e.g. live broadcasting) and non-linear 103 (e.g. video on demand (VOD)) and linear content 103 by communication lines 104 across a communication network 105 to the video edge 110 to service a device 140 (e.g. set-top box, tablet, smart phone, computer, etc.) of a user that subscribes to content subscription service. The video core 101 in the content processing and communication system also communicates with a resource manager 120 over communication lines 106 to provide information about the ingested and packaged linear 102 and non-linear 103 such as, for example, by maintaining a manifest file. The system 100 also comprising a back office 130 with business operations 131 (e.g. regulations, licenses, etc.), e-commerce 132 (e.g. subscriber billing, payments, etc.) and a self-care 133 portal (e.g. updates, remote servicing of devices, etc.). The user experience platform 150 may be a multi-dimensional platform to present content media to the user in a predetermined graphical user interface (GUI). A digital rights management (DRM) interface 151 that interfaces with the user device 140 and the resource manager 120 operates in the delayed DVR system and method 100 to authorize viewing of copyrighted content according to policies and rights management across the CDN 105.

Referring to FIGS. 1 and 2, the resource manager 120 is responsible for allocating, monitoring, and controlling resources, particularly streams and bandwidth, for recording and playback related services. The resource manager 120 may integrate a network DVR (nDVR) 121 for the recording and/or playback of linear 102 and non-linear content 103 by video control 122. According to a DVR embodiment, the device 140 may integrate a DVR recorder 143 for the recording and/or playback of linear 102 and non-linear content 103 in storage on the device. It is to be appreciated that the system 100 may provide the nDVR 121 resource in the cloud and DVR 143 on the device 120 for the user.

A preferred embodiment of the invention when recording TV, video and/or movie content media files, the video core 101 ingests non-linear 102 and linear content 103 and packages to encode in, for example, adaptive bit rate streaming (ABR) or in one or more multiple bit rate streams (e.g. MPEG streams extracted from the analog and digital TV signal streams, for and storage example, analog forms such as National Television Standards Committee (NTSC) or PAL broadcast, and digital forms such as Digital Satellite System (DSS), Digital Broadcast Services (DBS), or Advanced Television Standards Committee (ATSC). According to an embodiment, the delayed DVR system and method 100 may be configured to transfer content media files (e.g. frames of video) by way of Transmission Control Protocol (TCP)/Internet protocol suite (IP). TCP/IP transfer may use a variety of protocols (e.g. HTTP, HTTPS, SMTP, POP3, IMAP, SSH, FTP, Telnet, etc.) encapsulated in TCP to transfer and deliver across the CDN 105 network 105 from the video core 104 to the video edge 110 closest to the client device 140.

According to an embodiment, delayed DVR system and method 100 can be configured to use ABS streaming technologies to transmit the content media files over HTTP for distribution across the private CDN 105. In this manner, delayed DVR system and method 100 uses the advantages of ABS by dynamically monitoring CPU and memory capacity to make corresponding adjustments in the video quality of the transmitted content media by encoding the source linear and non-linear content (e.g. live broadcast, movie, video, etc.) at varying bit rates, and then segmenting each of the different bit rate streams. The segment length may be a predetermined size and duration, for example, between 2 and 10 seconds. The client or user's device 130 includes a player 146 to use the ABS advantageously to switch among the different bit rate segments, thereby locating the segments that correspond best to the bandwidth.

However, problems occur if the user utilizes the scheduler service 160 to begin the recording and storage of content media 102, 103 in response to a user input performing a DVR “function” that begins the caching and storage of such content media 102, 103 on the user device 140 and storage 147 or in the network using resource manager 120 and storage 123, or both, e.g. “record” function or “pause” function. For example, user experience (UX) interface 150 may have multiple streams utilizing the user's bandwidth on the CDN 105 as allocated by the resource manager 120. If the user requests a single DVR “record” function regarding non-linear or VOD content media 103, bandwidth utilization should be able to accommodate the request under normal circumstances. However, if the user requests multiple DVR “record” functions for multiple content media 103 assets banded with utilization may exceed that as allocated by the resource manager 120. In order to accommodate the multiple DVR “record” functions, according to an embodiment and aspect of the present invention, the delayed DVR system and method 100 overcomes these problems to detect one or more user characteristics to determine whether the system may delay delivery (i.e. caching and/or storing) of the content media 103 to a predetermined time when bandwidth resources should be more available to utilize. For example the delayed recording of all episodes of an entire season of “Game of Thrones”, herein categorized as multiple content media 103 assets, would available as the resource manager 120 can determine that the user characteristics indicate the user would not be immediately viewing such multiple content media 103 assets. The scheduler service 160 could then schedule the storage in the storage 123, 147, as appropriate, at a predetermined off-peak time (e.g. 3 AM). In this way, the user's present consumption of media content via the device 140 and user experience platform 150 would be able to maintain an optimum user experience within bandwidth restrictions and maintaining low latency.

According to another embodiment and aspect of the present invention, the delayed DVR system and method 100 can overcomes problems if the user were to request storage of linear or live broadcast content media 102 in connection with a “pause” DVR function. According to this embodiment, the resource manager 120 can determine from one or more user characteristics stored on the resource manager 120, or on the device 140, or both, that the user would not be viewing the content 102 immediately. One or more user characteristics may be configured to determine the time of day, previous pause history of the user to actual playback of the content, the nature of the content, and other data that indicates with reasonable certainty the user's characteristics. For example the delayed DVR system and method 100 may determine that the user watches the live broadcast of a baseball game up to a particular point (e.g. time such as 10 pm or 7^{th} inning approximate time) and uses the “pause” DVR function to store the remainder of the content media 102. The one or more user characteristics also may indicate that the particular program (i.e. live sporting event) and time (i.e. 10 PM) and even time of playback (e.g. lunchtime or plus 14 hours) are correlated. The resource manager 120 can determine from the user characteristics that the user would not be immediately viewing the content media 102. The scheduler service 160 could then schedule the storage of the linear media content 102 in the storage 123, 147, as appropriate, at a predetermined off-peak time (e.g. 3 AM). In this way, the user's present consumption of media content via the device 140 and user experience platform 150 would be able to maintain an optimum user experience within bandwidth restrictions and maintaining low latency.

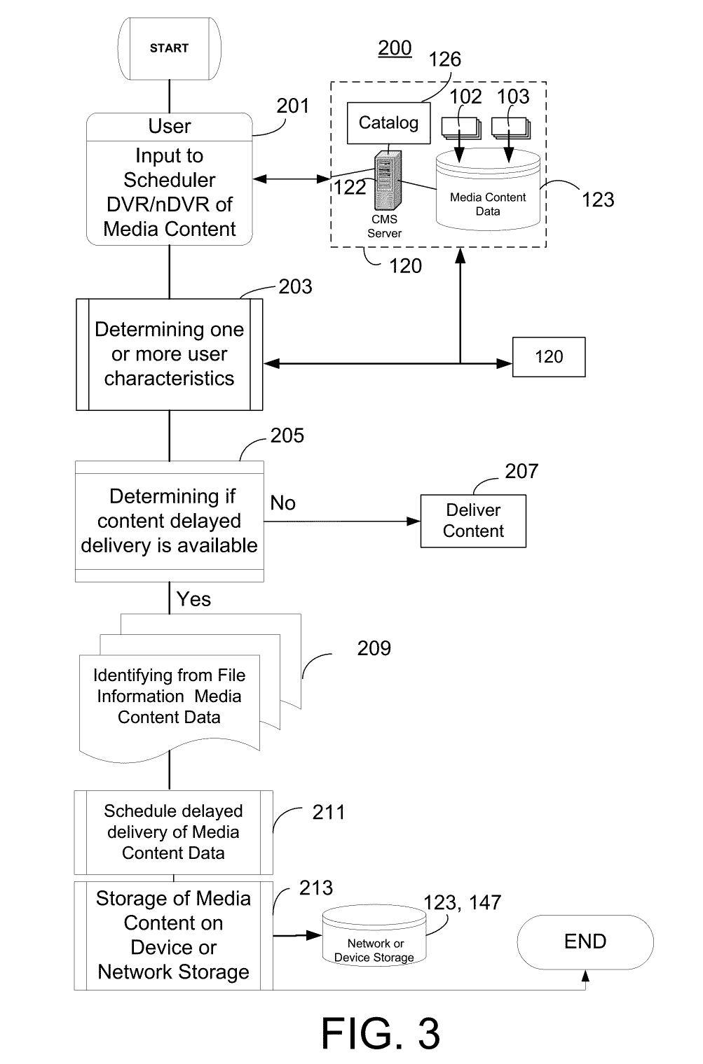

Referring now to FIG. 3, according to an embodiment of the method and/or process 200 of the present invention, can be utilized to delay the storage of content media 102, 103 on the user device 140 and storage 147, or on the network storage 123. In Step 201, the user provides an input of a DVR function that requires storage of the content media 102, 103 such as, for example, “pause” or “record” for the users account. The input is transmitted to the scheduler service 160 from the user device 140. The scheduler service 160 determines from the resource manager 120 and CDN 105 the identity of the media content 102, 103 and its location from various sources including the manifest files on the content management system 122, the media content data 123 stored in the origin server or 1^{st} tier cache, information from a catalog 126, and other information. In Step 203, the process 200 determines if one or more user characteristics are stored on the resource manager the resource manager 120, on the user device 140, or both. In Step 205, the process 200 determines if delayed delivery of the media content 102, 103 is available based on the one or more user characteristics. In Step 207, if delayed delivery of media content 102, 103 is not available, or a “No” is determined, the scheduler service 160 begins the recording and storage of the desired media content 102, 103. If the delayed delivery of media content 102, 103 is available or, a “Yes” is determined, in Step 209 the process 200 identifies the file information of the specific media content data 102, 103. In Step 211, the scheduler service 120 schedules the delayed delivery of the media data content 102, 103 at a predetermined time. In Step 213, upon the event of the predetermined time being reached, the process 200 begins the storage of the media content data 102, 103 on the device 140 storage 147 or in network storage 123 and the resource manager 120. Once all frames of the desired media content 102, 103 are delivered according to the user's request, the process 200 terminates or ends.

As shown in FIGS. 1 and 2, preferably the CDN 105 and resource manager 120 generates a report listing all current active streams of the user and stream status. The resource manager may be implemented as an API designed as a component that resides on the user device 140. The resource manager 120 is utilized for DVR recording and playback for the user experience on the device 140. The resource manager 120 may be configured to determine streaming configurations based on the bandwidth for the DVR 141 function according to the user device 140. The bandwidth resource usage may be reported by the resource manager 120, for example, a usage report, a global resource configuration, and/or an nDVR 121 related service API in the cloud. The resource manager 120 may be adapted to push notifications to all connected clients (UX platform(s) 150 and DVR(s) 140 with the latest resource statuses. The resource manager 120 is adapted to determine active streams and status changes, or in a sync operation, so as to allow the resource manager 120 to sync all resource statuses with the video edge (i.e. clients) streaming content media to the user's device 140 and/or DVR 141.

The resource manager 120 also is adapted to track and monitor all bandwidth resource usage locally so as to be able to determine if delaying the storage of media content 102, 103 is appropriate or possible according one or more user characteristics. DVR 143 connects and subscribes to the resource manager 120 to receive resource notifications. Near recording start time, whether it is X minutes (X is configurable by the DVR 143) or immediately before a recording starts (for impulse recordings), the DVR 143 must communicate with the resource manager 120 to request resource for a recording to start. The resource manager 120 determines whether a stream can be allocated based on a number of rules. The resource manager 120 then broadcasts the list of active streams and terminated streams to all connected UX platform 150 clients and the DVR 143. The UX platform 150 may present the information to the user as needed. In case of resource conflict, the user may choose to end some conflicting streams to manually resolve the conflict. If a recording cannot be started due to conflict constraints, the DVR 143 reports the blocked (or failed?) status back to the scheduler service 160. For any events that cause resource changes, which include recording starts/stops/fails, the DVR 143 must report such events to the resource manager 120. The resource manager 120 will update the resource statuses accordingly. The resource manager 120 broadcasts the list of streams including active streams and terminated/stopped/blocked streams to all connected UX platform 150 clients and DVR 143. The DVR 143 must process such notifications and take actions when necessary.

Referring to FIG. 2, the scheduler service 160 is utilized by the system when the user scheduling that may be comprised as a scheduler API and a schedule dB. The scheduler service 160 is utilized to create an event such as an impulse recording (e.g. record now) or a future recording of media content. The user utilizes the scheduler service 160 to specific DVR settings and preferences default DVR scheduling settings (offset, delete priority, recording priority, series, etc.) and other user privileges. The scheduler service 160 checks with the gatekeeper 155 for authentication, entitlement check, and other account data for the particular user.

In an exemplary embodiment, as is illustrated in FIGS. 1-2, a user has a device 140 which has may have application software 141 loaded in memory of the device 140, e.g. a set-top box or satellite DVR receiver. In establishing a recording, the device 140 checks with the gatekeeper module 188 to determine the users privileges, the user's metadata, the lineup data, performs a restrictions check such as passing an authorization token, and also may be used to purchase media content. The application software 141 may be configured as application programming interfaces (API). The application software 141 may be configured with a browser 142, a digital video recorder (DVR) 143, authorization token or restriction checker 144, a digital rights management (DRM) module 145, and content media player 146. The application software 141 is adapted to login to a gatekeeper 155 module of the resource manager 120. The gatekeeper 155 also utilizes APIs for various the subscribers' data services for policies of acquisition, persistence, and consumption for the media content that may be established by the back office 130. The gatekeeper 155 can be used in recording linear 102 and non-linear 103 media content including a lineup API 156, login API 157, playback API 158 and purchase API 159.

Similarly, when a user utilizes the DVR function such as “pause” or “record” the DVR function is managed by the resource manager 120. The resource manager 120 may be configured to determine whether a stream may be delayed based the one or more user characteristics as in the process 200 illustrated in FIG. 3. The user provides an input of a DVR function that requires storage of the content media 102, 103 such as, for example, a “pause” of live linear media content 102 or a “record” of non-linear, VOD content 103 for the users account. The resource manager 120 may be configured to manage bandwidth resources, policies, and applicable number of rules of the user account such as by the content management 122 and token restriction check 144. The user's DVR function input is transmitted to the scheduler service 160 from the user device 140. The scheduler service 160 determines from the resource manager 120 and CDN 105 the identity of the media content 102, 103 and its location from various sources including the manifest files on the content management system 122, the media content data 123 stored in the origin server or 1^{st} tier cache, information from a catalog 126, and other information. One or more user characteristics about the user are stored on the resource manager the resource manager 120, on the user device 140, or both. The delayed DVR system and method 100 if delayed delivery of the media content 102, 103 is available based on the one or more user characteristics. If delayed delivery of media content 102, 103 is not available, the scheduler service 160 begins the recording and storage of the desired media content 102, 103. If the delayed delivery of media content 102, 103 is available, the resource manager 120 identifies the file information of the specific media content data 102, 103. The scheduler service 120 schedules the delayed delivery of the media data content 102, 103 at a predetermined time. At the predetermined time being reached, the resource manager 120 delivers the paused or recorded requested media content data 102, 103 to storage of the on the device 140 (i.e. storage 147 or in network storage 123) and the resource manager 120. Once all frames of the desired media content 102, 103 are delivered according to the user's request, the delayed DVR system and method 100 (i.e. the process 200) terminates or ends whereby the user has the content 102, 103 for playback.

As shown in FIG. 1, the UX platform 150 may be implemented by an API that connects and subscribes to the resource manager 120 to receive resource notifications. For any DVR function for recording media content 102, 103 for playback later, the UX platform 150 communicates with the resource manager 120 to request the stream of the media content 102, 103. The resource manager 120 can be configured to determine whether a stream may be allocated based the resources, policies, and applicable number of rules such as by the content management 122 and token restriction check 144. The resource manager 120 then broadcasts the list of streams with their latest statuses to all connected devices 140 to UX platform 150 of clients and to the DVR 143 function. The UX platform 150 may present the information to the device 140 of a user as needed to resolve resource conflicts such as, for example, the user may choose to end some conflicting streams to manually resolve the conflict. The resource manager 120 broadcasts the list of streams including active streams and terminated/stopped/blocked streams to all connected UX platform 150 clients and Recorder. The UX platform 150 must process such notifications and take actions when necessary. For any user actions that cause bandwidth resource changes, which include a stream starts and a stream stops, the UX platform 150 must report such events to the resource manager 120. The resource manager 120 will update the resource statuses accordingly.

For example, when the user tunes to a particular linear channel (or flipping through channels), the UX platform 150 requests a single linear stream from the resource manager 120. If the user navigates away from viewing linear TV the resource manager 120 will release the stream from the device 140. Once the user starts viewing a channel, the UX platform 150 may be configured to report profile changes (such as registering 4K display device in the profile) to the resource manager 140 for further video control 122 of the available bandwidth and APS resource management. A Mosaic view takes up one stream regardless how many tiles will be displayed on that view, which is based on the assumption that all tiles on the Mosaic view together would utilize about the same bandwidth as a normal stream. When a user requests to view a video in full screen from a Mosaic view tile, UX kills the Mosaic view stream and requests a new stream for the full screen video. Any ongoing stream that gets absorbed into the Mosaic view will still be considered as an ongoing stream. That is, if a user goes back to the Mosaic view from playing a video (or an ongoing DVR recording is displayed in the Mosaic view), the video still consumes one stream until it gets stopped by the user.

While certain configurations of structures have been illustrated for the purposes of presenting the basic structures of the present invention, one of ordinary skill in the art will appreciate that other variations are possible which would still fall within the scope of the appended claims. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for managing a transmission of media content over an access link between a device and a source in a content delivery network (CDN), the method comprising the steps of:
receiving a service request from a requesting device request for delivery of a media content data,
processing said service request by determining one or more user characteristics of said request for delivery of said media content data;
determining using said one or more user characteristics to delay delivery of said service request of said media content data;
identifying said media content data of said service request for delivery;
scheduling the delivery of said media content data at a predetermined time; wherein subsequent delivery of said requested media content data is prioritized to minimize traffic over an access link between the source and the requesting device in the CDN;
delivering said media content data at said predetermined time; and
storing said media content data in storage located in said requesting device.

2. The method of claim 1, wherein said processing step is a DVR function for said service request.

3. The method of claim 1, wherein said processing step is a “record” DVR function for said service request.

4. The method of claim 1, wherein said processing step is a “pause” DVR function for said service request.

5. The method of claim 1, wherein said determining step further includes using said one or more user characteristics of the time of day, previous pause history of the user to actual playback of the content, the nature of the content, and other user characteristic data of said user that indicates with reasonable certainty the users characteristics.

6. The method of claim 1, wherein said determining of delayed delivery step further includes using data from the group consisting essentially of bandwidth resources, policies, network persistence, and/or applicable number of rules of the user account.

7. The method of claim 1, wherein said determining of delayed delivery step further includes delivering said media content data to said device of the user account at the typical viewing time of the content and/or just prior to the viewing time.

8. The method of claim 1, wherein said determining of delayed delivery step further includes delivering said media content data to said device of the user account on-demand at any time the user decides to watch said content.

9. A system for managing a transmission of media content over an access link between a device of a user and a source of the media content in a content delivery network (CDN), the system comprising:
a scheduler configured to:
operate in connection with a digital video recorder, whereby said scheduler is configured to respond to said service request of a “pause” of linear and/or a “record” for delivery of media content data;
a resource manager configured to:
receive said service request from said scheduler for delivery of said media content data,
identify said media content data of said service request for delivery;
process said service request by determining one or more user characteristics of said request for delivery of said media content data;
determine using said one or more user characteristics to delay delivery of said service request of said media content data;
utilize said scheduler to delay caching and/or storing said content media data at a predetermined time to conserved bandwidth across the CDN network based on said one or more user characteristics; and
a content processing and communication system communicatively coupled with said resource manager and configured to:
deliver said media content data at said predetermined time; and
store said media content data in storage located in said requesting device.

10. The system of claim 9 wherein said content processing and communication system is configured to provide information in a manifest file about content media data ingested and stored in the CDN.

11. The system of claim 9 wherein said content processing and communication system communicates with said scheduler for scheduling the delivery of said media content data at said predetermined time, whereby any subsequent delivery of said requested media content data is prioritized to minimize traffic over an access link between the source and the requesting device in the CDN.
